(19) United States
(12) Patent Application Publication
(10) Pub. No.: US 2008/0010541 A1
(43) Pub. Date: Jan. 10, 2008

(54) Integrated circuit device, debugging tool, debugging system, microcomputer, and electronic instrument

(75) Inventor: Makoto Kudo, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/804,788

(22) Filed: May 18, 2007

(30) Foreign Application Priority Data
May 19, 2006 (JP) 2006-140296

(51) Int. Cl. G06F 11/00

(52) U.S. Cl. 714/38

(57) ABSTRACT

An integrated circuit device (or a microcomputer) including a CPU, a fixed value input terminal, a fixed value holding section which receives a signal input through the fixed value input terminal and holds a fixed value when a reset signal is set at a first level; and a control section which controls the fixed value not to change when the reset signal is set at a second level.

Japanese Patent Application No. 2006-140296, filed on May 19, 2006, is hereby incorporated by reference in its entirety.

### BACKGROUND OF THE INVENTION

Several ascpects of the present invention relate to an integrated circuit device, a debugging tool, a debugging system, a microcomputer, and an electronic instrument.

In recent years, a microcomputer has been increasingly demanded which is incorporated in an electronic instrument such as a game device, a car navigation system, a printer, or a portable information terminal and achieves advanced information processing. Such an embedded microcomputer is usually mounted on a user board called a target system. In order to support the development of software which causes the target system to operate, a reduced-pin-count debugging tool (software development tool) such as an in-circuit emulator (ICE) is widely used (see JP-A-8-255096 and JP-A-11-282719).

As the ICE, a CPU-replacement type ICE as shown in FIG. 16 has been mainly used. When debugging software using the CPU-replacement type ICE, a microcomputer 302 is removed from a target system 300, and a probe 306 of a debugging tool 304 is connected to the target system 300 instead of the microcomputer 302. The debugging tool 304 emulates the operation of the removed microcomputer 302. The debugging tool 304 also executes various processes necessary for debugging.

However, the CPU-replacement type ICE has a problem in which the number of pins and the number of lines 308 of the probe 306 are increased. This makes it difficult to emulate the high-frequency operation of the microcomputer 302 (e.g. the frequency is limited to about 33 MHz). Moreover, the design of the target system 300 becomes difficult. In addition, the operating environment of the target system 300 (signal timing and load conditions) differs between the actual operation in which the microcomputer 302 is mounted and operated and the debugging mode operation in which the debugging tool 304 emulates the operation of the microcomputer 302. The CPU-replacement type ICE has another problem in which debugging tools with different designs and probes with different pin counts and positions must be used for different microcomputers, even if the microcomputers are derived products.

As an ICE which solve the problems of the CPU-replacement type ICE, an ICE is known in which debugging pins and functions for realizing the same functions as the ICE are mounted on a mass-produced chip. As such a debug-function-mounting type ICE, a microcomputer is known which includes an internal debugging module having an on-chip debugging function of communicating with a reduced-pin-count debugging tool (e.g. ICE) in clock synchronization and executing a debugging command input from the debugging tool, for example.

This microcomputer performs the debugging operation while communicating with the debugging tool in clock synchronization.

In this case, terminals (pins) are required for break input from the debugging tool to the microcomputer, break/run state output from the microcomputer to the debugging tool, data (e.g. debugging command) communication from the debugging tool to the microcomputer, data communication from the microcomputer to the debugging tool, a synchronization clock signal for communication between the debugging tool and the microcomputer, communication of additional information such as a trace from the microcomputer to the debugging tool, a ground line between the debugging tool and the microcomputer, and the like.

The number of debugging terminals (pins) is increased when providing such terminals (pins). On the other hand, it is preferable that the number of terminals required only during debugging and unnecessary for the end user be as small as possible. Moreover, an increase in the number of PKG terminals (pins) of the microcomputer results in an increase in IC cost and the like.

Furthermore, the degree of difficulty in board design is increased as the number of pins used for connecting the board and the debugging tool is increased. This decreases reliability, whereby the development cost and the development period of the board and the system are increased.

### SUMMARY

According to a first aspect of the invention, there is provided an integrated circuit device including a debugging module for on-chip debugging and a CPU, the integrated circuit device comprising:

a fixed value input terminal through which a signal from outside is input;

a fixed value holding section which receives a signal input through the fixed value input terminal and holds a fixed value when a reset signal is set at a first level; and

a control section which controls the fixed value held in the fixed value holding section not to change when the reset signal is set at a second level,

the fixed value input terminal being used for inputting the fixed value when the reset signal is set at the first level, and used for communication of the debugging module when the reset signal is set at the second level; and

the debugging module communicating with an external debugging tool through the fixed value input terminal when the reset signal is set at the second level.

According to a second aspect of the invention, there is provided an integrated circuit device including a debugging module for on-chip debugging and a CPU, the integrated circuit device comprising:

a fixed value input terminal through which a signal from the outside is input;

a fixed value holding section which receives a signal input from the outside through the fixed value input terminal and holds a fixed value when a reset signal is set at a first level; and

a control section which controls the fixed value holding section not to hold a signal input from the outside through the fixed value input terminal when the reset signal is set at a second level.

According to a third aspect of the invention, there is provided a microcomputer comprising any of the above-described integrated circuit devices.

According to a fourth aspect of the invention, there is provided an electronic instrument comprising:

the above-described microcomputer;

a data source of data to be processed by the microcomputer; and

an output device which outputs data processed by the microcomputer.

According to a fifth aspect of the invention, there is provided a debugging tool which communicates with an integrated circuit device including a debugging module for on-chip debugging and a CPU, the debugging tool comprising:

a fixed value output terminal through which a signal is output to the outside;

a fixed value holding section which holds a fixed value to be output to the outside through the fixed value output terminal when a reset signal is set at a first level; and

a debugging communication section which communicates with the integrated circuit device through the fixed value output terminal when the reset signal is set at a second level,

the fixed value output terminal being used for outputting the fixed value when the reset signal is set at the first level, and used for communication of the debugging communication section when the reset signal is set at the second level.

According to a sixth aspect of the invention, there is provided a debugging system including an integrated circuit device which includes a debugging module for on-chip debugging and a CPU, and a debugging tool which communicates with the integrated circuit device,

wherein the integrated circuit device includes:

a fixed value input terminal through which a signal from outside is input;

a fixed value holding section which receives a signal input through the fixed value input terminal and holds a fixed value when a reset signal is set at a first level; and

a control section which controls the fixed value held in the fixed value holding section not to change when the reset signal is set at a second level;

wherein the debugging tool includes:

a fixed value output terminal through which a signal is output to the outside;

a fixed value holding section which holds a fixed value to be output to the outside through the fixed value output terminal when the reset signal is set at the first level; and

a debugging communication section which communicates with the integrated circuit device through the fixed value output terminal when the reset signal is set at the second level;

wherein the fixed value input terminal is used for inputting the fixed value when the reset signal is set at the first level, and used for communication of the debugging module when the reset signal is set at the second level;

wherein the fixed value output terminal is used for outputting the fixed value when the reset signal is set at the first level, and used for communication of the debugging communication section when the reset signal is set at the second level;

wherein the fixed value holding section in the integrated circuit device communicates with the fixed value holding section in the debugging tool through the fixed value input terminal and the fixed value output terminal when the reset signal is set at the first level; and

wherein the debugging module communicates with the debugging communication section through the fixed value input terminal and the fixed value output terminal when the reset signal is set at the second level.

### BRIEF DESCRIPTION OF THE SEVERAL VIEWS OF THE DRAWING

FIG. 1 is a diagram illustrative of a debugging system according to one embodiment of the invention.

FIG. 2 is a diagram illustrative of a debugging system according to one embodiment of the invention.

FIG. 3 is a diagram illustrative of the configuration of an integrated circuit device according to one embodiment of the invention.

FIG. 4 is a diagram illustrative of the configuration of an integrated circuit device according to one embodiment of the invention.

FIG. 5 is a diagram illustrative of the operation of an integrated circuit device according to one embodiment of the invention.

FIG. 6 is a timing chart of an integrated circuit device according to one embodiment of the invention.

FIG. 7 is a timing chart of a debugging system according to one embodiment of the invention.

FIG. 8 is a diagram illustrative of the configuration of a debugging tool according to one embodiment of the invention.

FIG. 9 is a diagram illustrative of the configuration of an integrated circuit device according to a modification of one embodiment of the invention.

FIG. 10 is a timing chart of an integrated circuit device according to a modification of one embodiment of the invention.

FIG. 11 is a diagram illustrative of the configuration of a debugging tool according to a modification of one embodiment of the invention.

FIG. 12 is a timing chart of a debugging tool according to a modification of one embodiment of the invention.

FIG. 13 is a hardware block diagram showing an example of a microcomputer according to one embodiment of the invention.

FIG. 14 is a block diagram showing an example of an electronic instrument including a microcomputer.

FIGS. 15A to 15C show examples of outside views of various electronic instruments.

FIG. 16 shows an example of a conventional CPU-replacement type ICE.

### DETAILED DESCRIPTION OF THE EMBODIMENT

The invention may provide an integrated circuit device in which the number of terminals unnecessary for the end user is reduced, a debugging tool, a debugging system, a microcomputer, and an electronic instrument.

(1) According to one embodiment of the invention, there is provided an integrated circuit device including a debugging module for on-chip debugging and a CPU, the integrated circuit device comprising:

a fixed value input terminal through which a signal from outside is input;

a fixed value holding section which receives a signal input through the fixed value input terminal and holds a fixed value when a reset signal is set at a first level; and

a control section which controls the fixed value held in the fixed value holding section not to change when the reset signal is set at a second level,

the fixed value input terminal being used for inputting the fixed value when the reset signal is set at the first level, and used for communication of the debugging module when the reset signal is set at the second level; and

the debugging module communicating with an external debugging tool through the fixed value input terminal when the reset signal is set at the second level.

The integrated circuit device according to this embodiment includes the fixed value holding section. The fixed value holding section receives and holds the fixed value when the reset signal is set at the first level (before cancellation of the reset state). The fixed value holding section is controlled so that the fixed value does not change when the reset signal is set at the second level (after cancellation of the reset state). Therefore, the fixed value holding section can supply the fixed value to the integrated circuit device without transmitting and receiving a signal through the fixed value input terminal when the reset signal is set at the second level by configuring the fixed value holding section to be able to supply the fixed value to the integrated circuit device when the reset signal is set at the second level (after cancellation of the reset state).

On the other hand, the debugging module communicates with the external debugging tool and performs the debugging operation when the reset signal is set at the second level. Specifically, the debugging module need not communicate with the external debugging tool when the reset signal is set at the first level. In other words, it suffices that the debugging module communicate with the outside only when the reset signal is set at the second level, and the debugging module need not communicate with the outside when the reset signal is set at the first level.

According to this embodiment, it suffices that the fixed value holding section provided in the integrated circuit device communicate with the outside only when the reset signal is set at the first level, and that the debugging module communicate with the outside only when the reset signal is set at the second level. Therefore, this embodiment allows one terminal to play two roles depending on the level of the reset signal. Specifically, this embodiment allows one fixed value input terminal to function as a debugging communication terminal.

Therefore, according to this embodiment, an integrated circuit device can be provided in which the number of terminals used only during the debugging operation and unnecessary for the end user can be reduced.

The term “reset signal” used in this embodiment may be interpreted as a specific hardware interrupt signal. The fixed value held in the fixed value holding section may be set (changed) at a specific value or a value stored in an internal register of the CPU may be reset by the reset signal, for example.

The term “level of the reset signal” used in this embodiment may be the voltage level of the reset signal, for example. The voltage of the reset signal is usually set at the L level during a specific period after the commencement of the reset operation. The device is set in a reset state during this period. When the voltage of the reset signal is set at the H level, the reset state of the device is canceled, and the device starts to operate. In this embodiment, the L level may be the first level, and the H level may be the second level. In this case, the integrated circuit device is set in a reset state when the reset signal is set at the first level, and the integrated circuit device starts to operate when the reset signal is set at the second level. Therefore, the integrated circuit device can be appropriately operated by changing the connection destination of the fixed value input terminal depending on whether the reset signal is set at the first level or the second level, as described above.

(2) In this integrated circuit device,

the control section may include a circuit which controls a signal from the fixed value input terminal to be input to the fixed value holding section when the reset signal is set at the first level, or to be input to the debugging module when the reset signal is set at the second level.

According to this configuration, the integrated circuit device can be appropriately operated.

(3) In this integrated circuit device,

the fixed value holding section may include a flip-flop for holding the fixed value; and

the control section may include a select circuit which selects a signal from the fixed value input terminal or a signal output from the flip-flop based on the reset signal, and control the selected signal to be input to the flip-flop.

According to this configuration, the integrated circuit device can be appropriately operated.

In this embodiment, the select circuit may be configured so that a signal input through the fixed value input terminal is input to the flip-flop when the reset signal is set at the first level and a signal output from the flip-flop is input to the flip-flop when the reset signal is set at the second level.

(4) The integrated circuit device may comprise:

a plurality of the fixed value input terminals, the fixed value holding section holding a plurality of the fixed values from the fixed value input terminals while respectively associating the fixed values with the fixed value input terminals; and

a signal generation section which determines whether or not combination of the fixed values satisfies a predetermined pattern, and generates a predetermined debugging signal when the combination of the fixed values satisfies the predetermined pattern,

wherein the debugging module performs the on-chip debugging based on the predetermined debugging signal.

According to the above configuration, an integrated circuit device can be provided in which the number of terminals unnecessary for the end user can be further reduced. For example, the integrated circuit device may be configured so that the signal generation section (inside the integrated circuit device) generates a break signal to cause the CPU to transition to the debugging mode. According to this configuration, it is unnecessary for the integrated circuit device to receive a dedicated signal (break input) for causing the CPU to transition to the debugging mode from the outside, whereby a terminal (external terminal) for receiving the above signal becomes unnecessary. Note that the invention is not limited thereto. For example, the signal generation section may be configured to generate a signal such as a debugging clock signal.

(5) The integrated circuit device may comprise no dedicated external terminal for the debugging module to communicate with a debugging communication section included in the external debugging tool.

(6) According to one embodiment of the invention, there is provided an integrated circuit device including a debugging module for on-chip debugging and a CPU, the integrated circuit device comprising:

a fixed value input terminal through which a signal from the outside is input;

a fixed value holding section which receives a signal input from the outside through the fixed value input terminal and holds a fixed value when a reset signal is set at a first level; and

a control section which controls the fixed value holding section not to hold a signal input from the outside through the fixed value input terminal when the reset signal is set at a second level.

According to this embodiment, an integrated circuit device can be provided in which the number of terminals unnecessary for the end user can be reduced.

(7) According to one embodiment of the invention, there is provided a microcomputer comprising any of the above-described integrated circuit devices.

(8) According to one embodiment of the invention, there is provided an electronic instrument comprising:

the above-described microcomputer;

a data source of data to be processed by the microcomputer; and

an output device which outputs data processed by the microcomputer.

(9) According to one embodiment of the invention, there is provided a debugging tool which communicates with an integrated circuit device including a debugging module for on-chip debugging and a CPU, the debugging tool comprising:

a fixed value output terminal through which a signal is output to the outside;

a fixed value holding section which holds a fixed value to be output to the outside through the fixed value output terminal when a reset signal is set at a first level; and

a debugging communication section which communicates with the integrated circuit device through the fixed value output terminal when the reset signal is set at a second level,

the fixed value output terminal being used for outputting the fixed value when the reset signal is set at the first level, and used for communication of the debugging communication section when the reset signal is set at the second level.

In the debugging tool according to this embodiment, the debugging communication section communicates with an external device (debugs) utilizing the fixed value output terminal.

Therefore, according to this embodiment, a debugging tool can be provided which can cause an integrated circuit device, in which the fixed value input terminal achieves a fixed value input function and a debugging communication function, to operate using the minimum number of terminals (external terminals).

(10) In this debugging tool, the fixed value holding section may include a pull-up or pull-down resistor.

(11) The debugging tool may comprise no dedicated external terminal for the debugging communication section to communicate with the debugging module.

(12) According to one embodiment of the invention, there is provided a debugging system including an integrated circuit device which includes a debugging module for on-chip debugging and a CPU, and a debugging tool which communicates with the integrated circuit device,

wherein the integrated circuit device includes:

a fixed value input terminal through which a signal from outside is input;

a fixed value holding section which receives a signal input through the fixed value input terminal and holds a fixed value when a reset signal is set at a first level; and

a control section which controls the fixed value held in the fixed value holding section not to change when the reset signal is set at a second level;

wherein the debugging tool includes:

a fixed value output terminal through which a signal is output to the outside;

a fixed value holding section which holds a fixed value to be output to the outside through the fixed value output terminal when the reset signal is set at the first level; and

a debugging communication section which communicates with the integrated circuit device through the fixed value output terminal when the reset signal is set at the second level;

wherein the fixed value input terminal is used for inputting the fixed value when the reset signal is set at the first level, and used for communication of the debugging module when the reset signal is set at the second level;

wherein the fixed value output terminal is used for outputting the fixed value when the reset signal is set at the first level, and used for communication of the debugging communication section when the reset signal is set at the second level;

wherein the fixed value holding section in the integrated circuit device communicates with the fixed value holding section in the debugging tool through the fixed value input terminal and the fixed value output terminal when the reset signal is set at the first level; and

wherein the debugging module communicates with the debugging communication section through the fixed value input terminal and the fixed value output terminal when the reset signal is set at the second level.

According to this embodiment, a debugging system can be provided which includes an integrated circuit device in which the number of terminals unnecessary for the end user can be reduced and a debugging tool which can cause the integrated circuit device to operate using the minimum number of terminals (external terminals).

(13) In this debugging system, the integrated circuit device may include no dedicated external terminal for the debugging module to communicate with the debugging communication section.

Embodiments of the invention will be described below with reference to the drawings. Note that the invention is not limited to the following embodiments. The invention includes configuration in which the components in the following description are arbitrarily combined.

1. Debugging System

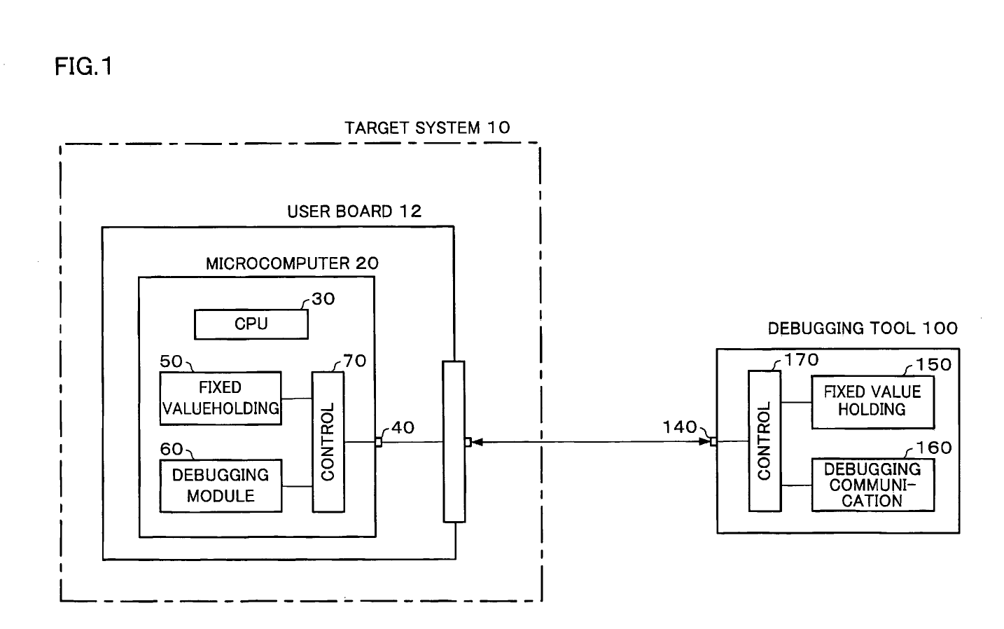

FIGS. 1 to 12 illustrate a debugging system according to one embodiment of the invention.

The debugging system according to this embodiment includes a reduced-pin-count debugging tool 100 (e.g. ICE) and a target system 10 as the debugging target of the debugging tool 100. Each element is described below.

1.1. Target System

1.1.1. Configuration of Target System

The configuration of the target system 10 is described below with reference to FIGS. 1 to 4.

The target system 10 has a structure in which a microcomputer 20 (example of integrated circuit device including CPU 30) is mounted on a user board 12 (substrate). A semiconductor integrated circuit device such as a memory and an oscillator (clock oscillator 14) such as a crystal oscillator which generates and outputs a digital clock signal may be mounted on the user board 12 in addition to the microcomputer 20. A reset signal generation section (reset IC 16) which generates a reset signal may also be mounted on the user board 12.

The microcomputer 20 may be configured so that a fixed value held in a fixed value holding section 50 is reset (set or changed) or a value stored in an internal register of the CPU 30 is reset by the reset signal output from the reset IC 16, for example. The term “reset signal” used herein may be interpreted as a specific hardware interrupt signal.

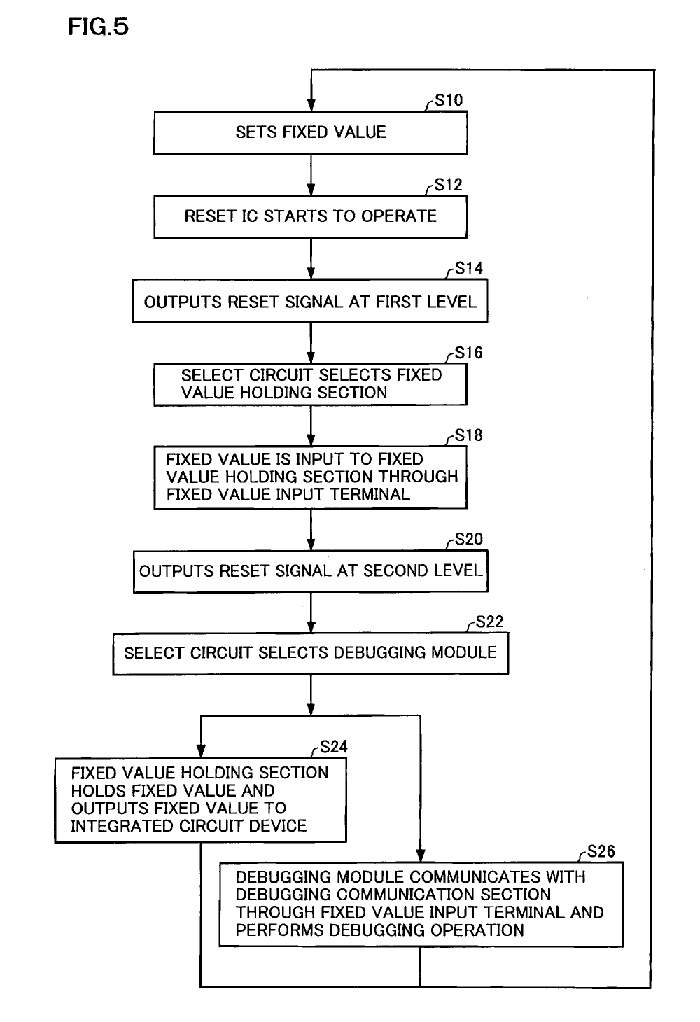

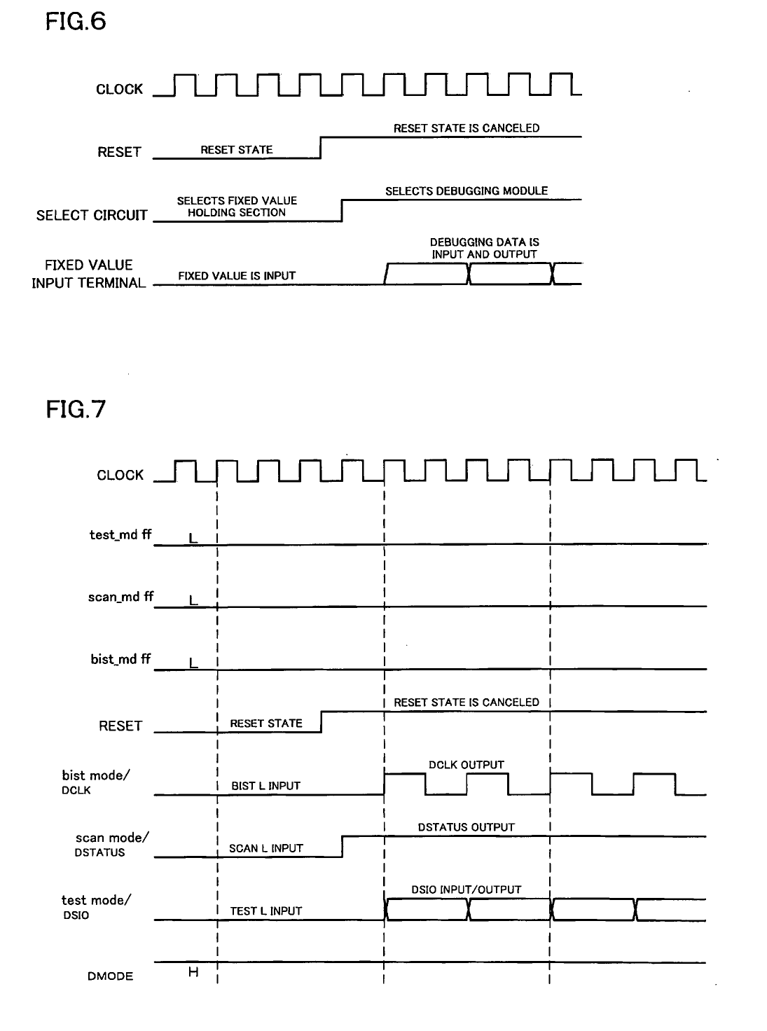

The level of the reset signal may be classified into a first level (e.g. L level) and a second level (e.g. H level). The microcomputer 20 is set in a reset state when the reset signal is set at the first level, and the reset state of the microcomputer 20 is canceled when the reset signal is set at the second level. The reset IC 16 outputs the reset signal set at the first level immediately after the commencement of the reset operation, and outputs the reset signal set at the second level when a specific period has elapsed (see timing charts shown in FIGS. 6 and 7, for example). The level of the reset signal may be determined based on the voltage level, or may be determined based on the period of time elapsed after the commencement of the reset operation of the reset IC 16.

The clock oscillator 14 outputs a clock signal for inputting the reset signal to the microcomputer 20 and the debugging tool 100 in synchronization.

The microcomputer 20 includes the CPU 30. The CPU 30 executes various instructions and includes internal registers. The internal registers include general-purpose registers R0 to R15, special registers such as a stack pointer register (SP), an AHR (high register for product-sum calculation result data), and an ALR (low register for product-sum calculation result data), and the like. The CPU 30 executes a user program in a user mode, executes a test program and a test command in a test mode, and executes a monitor program and a debugging command in a debugging mode. The operation (mode) of the CPU 30 (microcomputer 20) may be determined based on the fixed value held in the fixed value holding section 50.

In this embodiment, the microcomputer 20 is set in a reset state when the reset signal is set at the first level, and the reset state of the microcomputer 20 is canceled when the reset signal is set at the second level, as described above.

The microcomputer 20 includes a fixed value input terminal 40. The fixed value input terminal 40 is configured so that at least a signal from the outside can be input therethrough. The fixed value input terminal 40 may be configured so that a signal can be output to the outside therethrough.

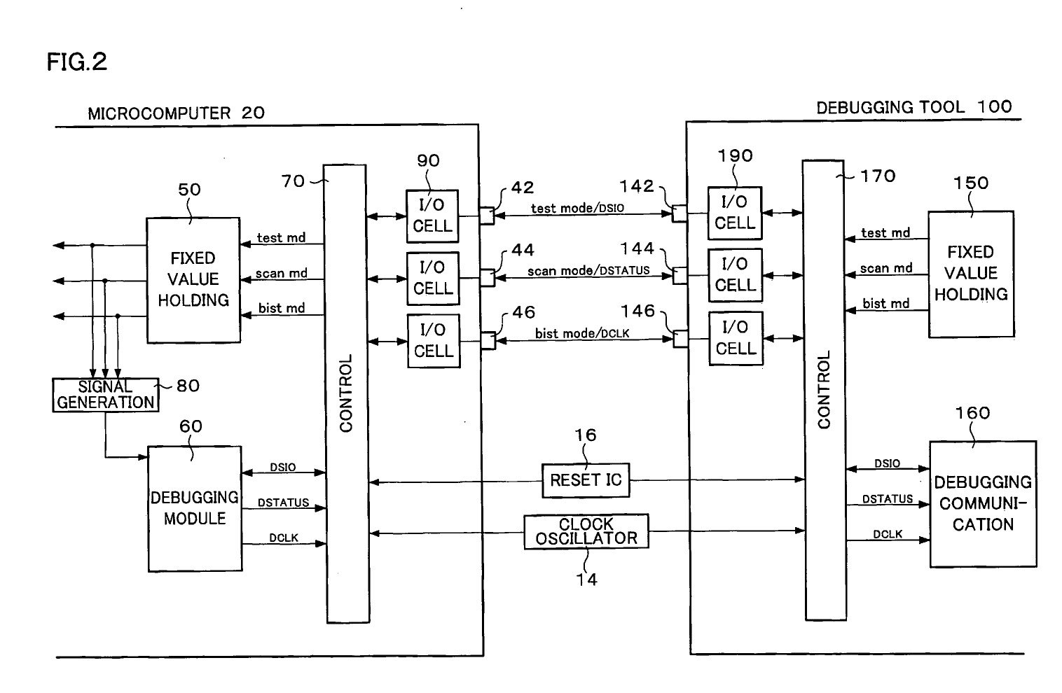

As shown in FIG. 2, the microcomputer 20 according to this embodiment includes a plurality of fixed value input terminals 40. As examples of the fixed value input terminal 40, a test mode pin, a scan mode pin, a bist mode pin, a PLL pin, and the like can be given. In the example shown in FIG. 2, only a test mode pin 42, a scan mode pin 44, and a bist mode pin 46 are illustrated, and other terminals are omitted. The fixed value may be 1-bit data representing 0 or 1. The fixed value may be data for determining the operation (e.g. test mode/scan mode/bist mode/debugging mode/user mode) of the CPU 30, for example. Note that the fixed value is not limited thereto.

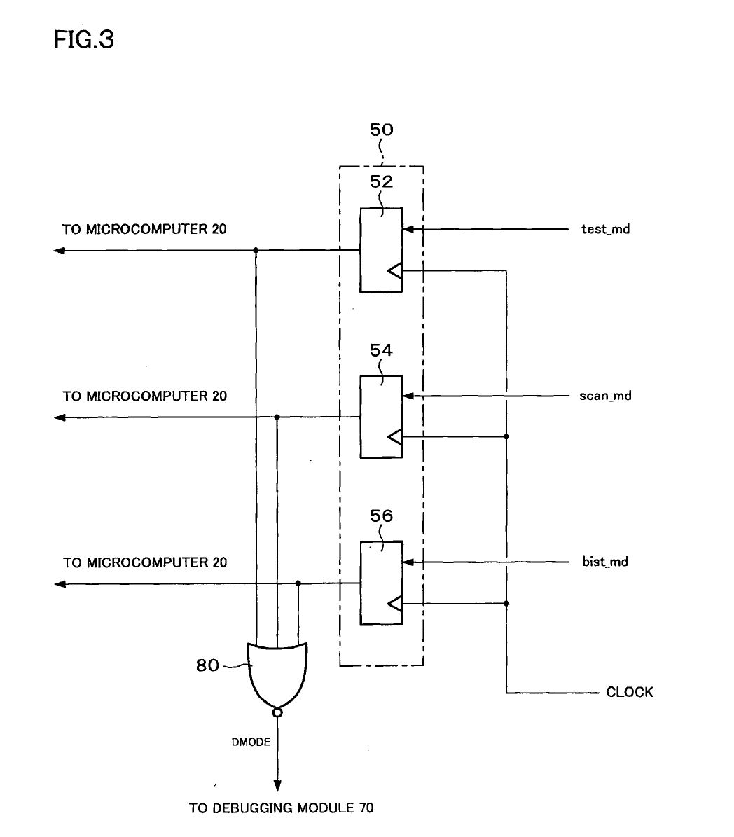

The microcomputer 20 includes the fixed value holding section 50. The fixed value holding section 50 has a function of holding the fixed value input from the outside of the microcomputer 20 through the fixed value input terminal 40 and outputting the fixed value to the microcomputer 20. FIG. 3 is a diagram showing an example of the configuration of the fixed value holding section 50. As shown in FIG. 3, the fixed value holding section 50 may include a plurality of flip-flops 52 to 56. In this case, each of the flip-flops 52 to 56 corresponds to one of the fixed value input terminals 42 to 46. This allows the fixed value holding section 50 to hold the fixed values input through the fixed value input terminals 42 to 46 while associating the fixed values with the respective fixed value input terminals 42 to 46.

In this embodiment, the fixed value holding section 50 receives a signal input through the fixed value input terminal 40 and holds a fixed value when the reset signal is set at the first level, and is controlled by a control section 70 so that the fixed value held in the fixed value holding section 50 does not change when the reset signal is set at the second level. The fixed value holding section 50 is configured to output the fixed value held therein to the microcomputer 20 when the reset signal is set at the second level. According to this embodiment, since the fixed value can be supplied to the integrated circuit device when the reset signal is set at the second level without receiving the fixed value input through the fixed value input terminal 40, the microcomputer 20 can determine the operation mode of the CPU 30.

The microcomputer 20 includes a debugging module 60. The debugging module 60 has a function of communicating with the debugging tool 100 (debugging communication section 160) and performing on-chip debugging. In this embodiment, the debugging module 60 communicates with the debugging tool 100 through the fixed value input terminal 40 when the reset signal is set at the second level.

In the microcomputer 20 according to this embodiment, the fixed value need not be input through the fixed value input terminal 40 when the reset signal is set at the second level, as described above. Therefore, the microcomputer 20 according to this embodiment allows the fixed value input terminal 40 to be utilized to transmit and receive debugging data when the reset signal is set at the second level. In particular, since debugging is a process performed by operating the CPU 30 only when the reset signal is set at the second level, the fixed value input terminal 40 can achieve the above functions by selectively utilizing the fixed value input terminal 40 depending on the level of the reset signal.

The debugging module 60 includes a ROM, a RAM, a control register, and the like, and performs processes (e.g. I/O interface with the debugging module, debugging command analysis, and interrupt from the user program to the monitor program) necessary to cause the CPU 30 to execute the monitor program and the debugging command in the debugging mode.

The monitor program is stored in the ROM of the debugging module 60. The information stored in the internal registers of the CPU 30 is saved in the RAM when a transition to the debugging mode occurs (when a break occurs in the test mode or the like). This allows the program to be properly resumed after the completion of the debugging mode. Moreover, the information stored in the internal registers can be read using a command of the monitor program, for example.

The control register is a register for controlling various debugging processes, and includes a step execution enable bit, a break enable bit, a break address bit, a trace enable bit, and the like. The debugging processes are realized by causing the CPU 30 which operates according to the monitor program to write data into each bit of the control register or read data from each bit of the control register.

The microcomputer 20 includes the control section 70. The control section 70 controls the fixed value holding section 50 (microcomputer 20) so that the fixed value held in the fixed value holding section 50 does not change when the reset signal is set at the second level. This makes it possible to cause the CPU 30 to perform a specific operation when the reset signal is set at the second level without receiving the fixed value through the fixed value input terminal 40, whereby the fixed value input terminal 40 can be used for achieving another function.

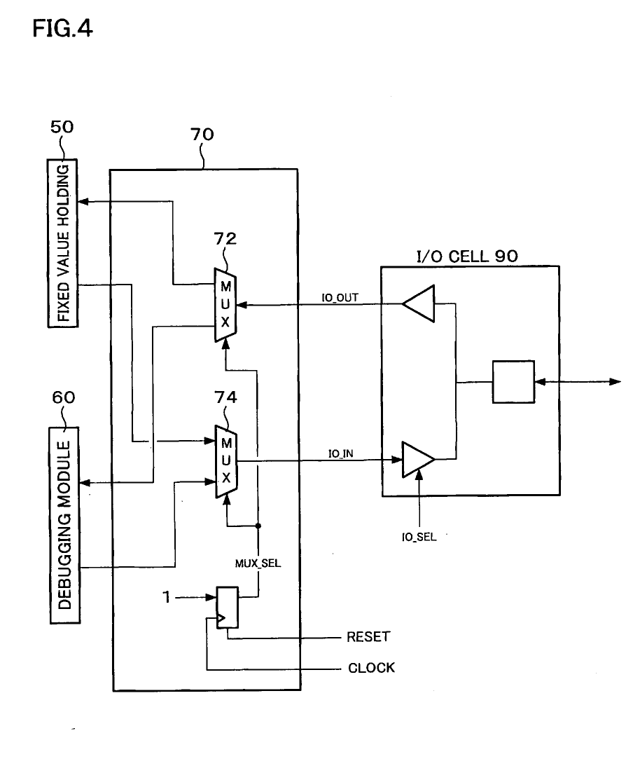

In this embodiment, the control section 70 may be configured to include a select circuit (MUX). Specifically, the control section 70 may be configured to include select circuits (MUX) 72 and 74, as shown in FIG. 4.

The select circuit 72 is a circuit for selecting the input destination of a signal (IO_OUT signal) output from an I/O cell 90 to the microcomputer 20. Specifically, the select circuit 72 selects (determines) the fixed value holding section 50 or the debugging module 60 as the input destination of the signal (IO_OUT signal) output from the I/O cell 90. In this embodiment, the select circuit 72 controls the microcomputer 20 so that the signal input through the fixed value input terminal 40 is input to the fixed value holding section 50 when the reset signal is set at the first level, and is input to the debugging module 60 when the reset signal is set at the second level. Specifically, the microcomputer 20 is controlled so that the signal input through the fixed value input terminal 40 is not input-to the fixed value holding section 50 when the reset signal is set at the second level. Therefore, the fixed value held in the fixed value holding section 50 can be maintained at the same value when the reset signal is set at the second level.

The select circuit 74 is a circuit for selecting a signal (IO_IN signal) input to the I/O cell 90. The select circuit 74 selects the fixed value holding section 50 or the debugging module 60 to input a signal to the I/O cell 90.

In summary, the select circuits 72 and 74 are configured so that the I/O cell 90 transmits and receives a signal to and from the fixed value holding section 50 when the reset signal is set at the first level, and the I/O cell 90 transmits and receives a signal to and from the debugging module 60 when the reset signal is set at the second level. This realizes a configuration in which a signal is not input to the fixed value holding section 50 when the reset signal is set at the second level, whereby the microcomputer 20 can be controlled so that the fixed value does not change when the reset signal is set at the second level.

In this embodiment, the microcomputer 20 is configured so that data output from the fixed value holding section 50 can be input to the I/O cell 90, as shown in FIG. 4. Note that the invention is not limited thereto. Specifically, the microcomputer 20 according to the invention may be configured so that data output from the fixed value holding section 50 is not input to the I/O cell 90. In this case, the control section 70 need not include the select circuit 74.

As shown in FIGS. 2 and 3, the microcomputer 20 may include a signal generation section 80. The signal generation section 80 determines whether or not the combination of the fixed values held in the fixed value holding section 50 (or, input to the fixed value holding section 50) satisfies a specific pattern, and generates a specific debugging signal and outputs the generated signal to the debugging module 60 when the combination of the fixed values satisfies the specific pattern. The debugging module 60 performs the debugging operation based on the signal generated by the signal generation section 80. This enables an integrated circuit device to be provided in which the number of terminals unnecessary for the end user can be further reduced.

The signal generation section 80 may be configured to generate a break signal and output the generated break signal to the debugging module 60, for example. This makes it possible to cause the CPU to transition to the debugging mode by utilizing the pattern of the fixed values. Specifically, it is unnecessary to provide the microcomputer 20 with a dedicated terminal for inputting a signal for causing the CPU to transition to the debugging mode. Note that the signal output from the signal generation section 80 is not limited to the break input signal.

The signal generation section 80 may be configured to output a specific debugging signal to the debugging module 60 when signals set at the L level are input through the fixed value input terminals 42 to 46, for example.

Note that the microcomputer 20 according to the invention may not include the signal generation section 80. In this case, the microcomputer may be configured so that the above-mentioned break signal is input through another fixed value input terminal (e.g. PLL pin), for example.

1.1.2. Operation of Target System

The operation of the target system 10 (microcomputer 20) is described below with reference to FIGS. 5 to 7.

FIG. 5 is a flowchart diagram illustrative of the operation of the microcomputer 20.

First, the fixed value is set (step S10). The fixed value may be set by a fixed value holding section 150 (fixed value output section) included in the debugging tool 100, or may be set by a fixed value setting section (not shown) provided on the user board 12. The fixed value may be set according to a program provided in advance. Or, the fixed value may be set by the user.

The reset IC 16 then starts to operate (step S12). The reset IC 16 outputs the reset signal set at the first level (step S14). The control section 70 (select circuits 72 and 74) selects the fixed value holding section 50 when the reset signal is set at the first level (step S16), and the fixed value is input to the fixed value holding section 50 through the fixed value input terminal 40 (step S18).

The reset IC 16 then outputs the reset signal set at the second level (i.e. the reset signal is changed to the second level) (step S20). This causes the control section 70 (select circuits 72 and 74) to select the debugging module 60 (step S22), and the fixed value holding section 50 is controlled so that the fixed value does not change. After the control section 70 has selected the debugging module 60 (after the reset signal has been changed to the second level), the fixed value holding section 50 outputs the fixed value held therein to the microcomputer 20 (step S24). The debugging module 60 communicates with the debugging tool 100 through the fixed value input terminal 40, and performs the debugging operation (step S26).

FIG. 6 is a timing chart showing the operations of the clock signal generated by the clock oscillator 14, the reset signal, the control section 70 (select circuits 72 and 74), and the fixed value input terminal 40. When the reset signal has changed from the first level (L level) to the second level (H level), the reset state of the microcomputer 20 is canceled. When the reset signal is set at the first level, the select circuits 72 and 74 select the fixed value holding section 50, and the fixed value is input through the fixed value input terminal 40. When the reset signal is set at the second level, the select circuits 72 and 74 select the debugging module 60, and debugging communication data is input and output through the fixed value input terminal.

FIG. 7 is a timing chart showing the operation of the microcomputer 20. When the reset signal is set at the first level, signals set at the L level are input through the fixed value input terminals 40 (test mode pin 42, scan mode pin 44, and bist mode pin 46), and signals set at the L level are input to the fixed value holding section 50 (flip-flops 52 to 56). In this embodiment, when the signal generation section 80 detects that the signals set at the L level are input through all of the fixed value input terminals 40, the signal generation section 80 outputs a DMODE signal set at the H level. When the reset signal has changed to the H level, a DCLK signal (synchronization clock signal for debugging communication) is output through the bist mode pin 46, a DSTATUS signal is output through the scan mode pin 44, and a DSIO signal is bidirectionally input and output through the test mode pin 42. According to this embodiment, since the fixed value held in the fixed value holding section 50 (flip-flops 52 to 56) does not change even after the reset signal has changed to the H level, the CPU 30 can perform the debugging operation without transitioning to the test mode or the like.

1.1.3. Summary

In the microcomputer 20 (integrated circuit device) according to this embodiment, the fixed value input terminal 40 is used for inputting the fixed value to the fixed value holding section 50 when the reset signal is set at the first level, and is used for the debugging module 60 to communicate when the reset signal is set at the second level, as described above. Therefore, the number of terminals used only for communication with the debugging tool 100 (debugging operation) can be reduced.

Specifically, since an integrated circuit device including a debugging module for on-chip debugging must transmit and receive the DMODE signal, the DCLK signal, the DSTATUS signal, and the DSIO signal, the integrated circuit device includes four or more dedicated debugging module communication terminals in addition to a fixed value input terminal. On the other hand, this embodiment allows the fixed value input terminal 40 to serve as the debugging communication terminal. Therefore, an integrated circuit device can be provided in which the number of dedicated debugging module communication terminals can be reduced to three or less (one, two, or three). Specifically, this embodiment can provide an integrated circuit device in which the number of terminals unnecessary for the end user is reduced.

The integrated circuit device according to this embodiment may not include the dedicated debugging communication terminal (external terminal) (i.e. dedicated external terminal for the debugging module 60 to communicate with the debugging communication section 160 (debugging tool 100)). The dedicated debugging communication terminal can be omitted from the integrated circuit device by allowing one of the fixed value input terminals to function as the terminal necessary for the debugging module 60 to communicate with the debugging communication section 160.

In this case, the integrated circuit device may be configured to include a dedicated terminal for transmitting and receiving a signal which does not activate the debugging module 60 and the debugging communication section 160, such as a ground terminal provided between the debugging module 60 and the debugging communication section 160.

1.2. Debugging Tool

The debugging tool 100 is described below with reference to FIGS. 1, 2, and 8.

The debugging tool 100 includes a fixed value output terminal 140. The fixed value output terminal 140 is configured so that at least a signal can be output to the outside therethrough. The fixed value output terminal 140 may be configured so that a signal from the outside can be input therethrough. In this embodiment, the fixed value output terminal 140 is configured so that the fixed value output terminal 140 can transmit and receive a signal to and from the fixed value holding section 150 and the debugging communication section 160 (debugging communication section). In the example shown in FIG. 2, a test mode pin 142, a scan mode pin 144, and a bist mode pin 146 are illustrated as the fixed value output terminals 140. Note that the fixed value output terminal 140 is not limited thereto.

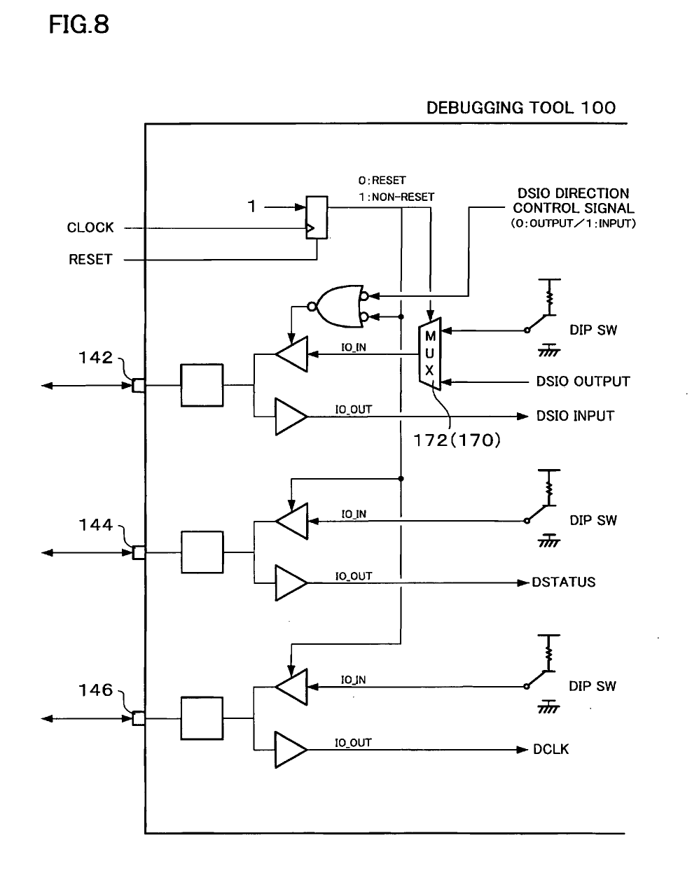

The debugging tool 100 includes the fixed value holding section 150. The fixed value holding section 150 holds the fixed value output through the fixed value output terminal 140 when the reset signal is set at the first level. The fixed value held in the fixed value holding section 150 is input to the fixed value holding section 50 through the fixed value output terminal 140 and the fixed value input terminal 40. The fixed value holding section 150 may be configured to output a signal set at the H level or the L level using a DIP switch, for example (see FIG. 8). Or, the fixed value holding section 150 may be configured using a storage device.

The debugging tool 100 includes the debugging communication section 160. The debugging communication section 160 has a function of communicating with the debugging module 60 provided in the microcomputer 20 (integrated circuit device) and causing the debugging module 60 to perform the on-chip debugging operation when the reset signal is set at the second level. Specifically, the debugging communication section 160 transmits and receives debugging data to and from the debugging module 60 and causes the debugging module 60 to perform the on-chip debugging operation. The term “debugging data” refers to various types of data transferred between the debugging module 60 and the debugging communication section 160 during the on-chip debugging operation. As examples of the debugging data, a debugging command, a status command, various types of data, and the like can be given.

The debugging tool 100 includes a control section 170. The debugging tool 100 is controlled by the control section 170 so that a signal is transferred between the fixed value output terminal 140 and the fixed value holding section 150 when the reset signal is set at the first level, and a signal is transferred between the fixed value output terminal 140 and the debugging communication section 160 when the reset signal is set at the second level. The control section 170 may be configured so that a select circuit switches the signal transfer destination of the fixed value output terminal 140.

FIG. 8 is a diagram illustrative of the details of the debugging tool 100. In the example shown in FIG. 8, the debugging tool 100 includes a select circuit (MUX) 172 as the control section 170. The select circuit 172 selects the DIP switch (DIP SW) as an example of the fixed value holding section 150 or a DSIO output, and outputs an IO_IN signal to an I/O cell 190. The select circuit 172 selects the signal from the DIP switch (DIP SW) as the fixed value holding section 150 when the reset signal is set at the first level, and selects the DSIO output as the debugging communication section 160 when the reset signal is set at the second level.

When utilizing the DIP switch (DIP SW) as the fixed value holding section 150, it is unnecessary to input a signal from the fixed value output terminal 140 to the fixed value holding section 150. Therefore, the debugging tool 100 may be configured so that the debugging tool 100 does not include a select circuit which switches the output destination of the IO_OUT signal, as shown in FIG. 8.

In the example shown in FIG. 8, the debugging communication section 160 is configured to merely receive the DSTATUS signal and the DCLK signal. According to this configuration, it is possible to allow the fixed value output terminals 144 and 146 to function as the debugging communication terminals by causing the debugging communication section 160 to receive the output (IO_OUT) from the I/O cell 190 of the debugging tool 100 and causing the fixed value holding section (DIP SW) to input a signal (IO_IN) to the I/O cell 190.

The debugging tool 100 according to this embodiment may be configured as described above. According to the debugging tool 100, the fixed value output terminal 140 is used for outputting the fixed value when the reset signal is set at the first level, and is used for the debugging communication section 160 to communicate when the reset signal is set at the second level.

Specifically, the debugging tool 100 allows the fixed value output terminals 140 (142 to 146) to be utilized for the debugging communication section 160 to communicate. Therefore, a debugging tool can be provided which can cause an integrated circuit device to operate using the minimum number of terminals (external terminals) by utilizing the debugging tool 100 as a debugging tool for the integrated circuit device (microcomputer 20) configured so that the fixed value input terminal 40 is allowed to function as the debugging communication terminal.

1.3. Debugging System

The debugging system according to this embodiment includes the integrated circuit device (microcomputer 20) which includes the debugging module 60 and in which the number of terminals (external terminals) unnecessary for the user can be reduced as much as possible, and the debugging tool 100 which can cause the integrated circuit device to operate using the minimum number of terminals (external terminals). Therefore, according to this embodiment, an integrated circuit device in which the number of terminals unnecessary for the end user is reduced, and a debugging system which enables the integrated circuit device to be manufactured with high reliability can be provided.

Note that the debugging system according to the invention is not limited thereto. In particular, the invention also includes a debugging system in which various functions described for the debugging tool 100 are realized outside the debugging tool 100 (e.g. on the user board 12). Since this debugging system can also cause an integrated circuit device, in which the number of terminals unnecessary for the end user is reduced as much as possible, to perform on-chip debugging, an integrated circuit device can be manufactured (developed) in which the number of terminals unnecessary for the end user is reduced.

1.4. Modification

1.4.1. First modification

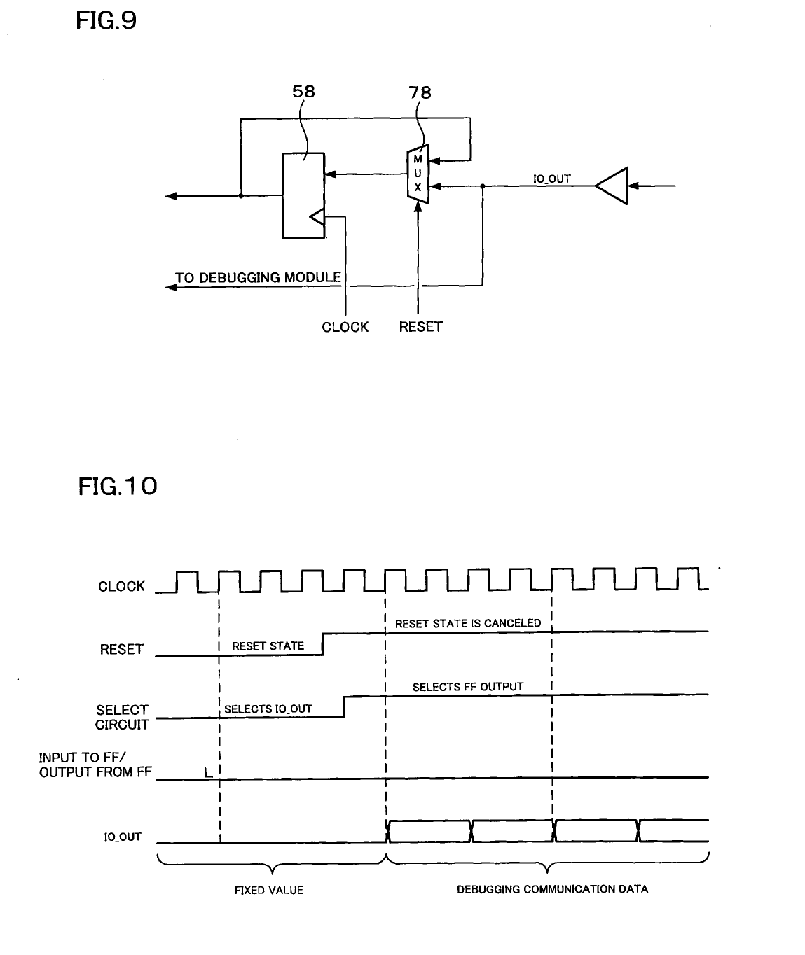

FIGS. 9 and 10 are diagrams illustrative of a modification of the integrated circuit device (microcomputer).

This integrated circuit device includes a flip-flop 58 as the fixed value holding section 50. The integrated circuit device includes a select circuit 78 as the control section. The select circuit 78 is configured to select the signal input through the fixed value input terminal 40 or the signal output from the flip-flop 58 based on the reset signal, and input the selected signal to the flip-flop 58. The integrated circuit device is configured so that the output signal (IO_OUT) from the I/O cell 90 is branched and input to the select circuit 78 and the debugging module 60.

The integrated circuit device is configured so that the select circuit 78 selects the output signal (IO_OUT) from the I/O cell 90 when the reset signal is set at the first level, and selects the output from the flip-flop 58 when the reset signal is set at the second level. Therefore, when the reset signal set at the first level is output from the reset IC 16, the select circuit 78 selects the output signal from the I/O cell 90 so that the fixed value is input to and held in the flip-flop 58. When the reset IC 16 outputs the reset signal set at the second level, the select circuit 78 selects the output from the flip-flop 58 so that the fixed value held in the flip-flop 58 is input to the flip-flop 58. Therefore, the integrated circuit device can be controlled so that the fixed value held in the fixed value holding section (flip-flop 58) does not change when the reset signal is set at the second level without being affected by the debugging communication data output from the I/O cell 90.

FIG. 10 is a timing chart showing the operation of the integrated circuit device. As shown in FIG. 10, the reset state is canceled when the reset signal has changed from the L level to the H level, and the debugging communication data is input as the IO_OUT signal. In this case, since the selection of the select circuit 78 also changes, the fixed value held in the flip-flop 58 does not change.

1.4.2. Second Modification

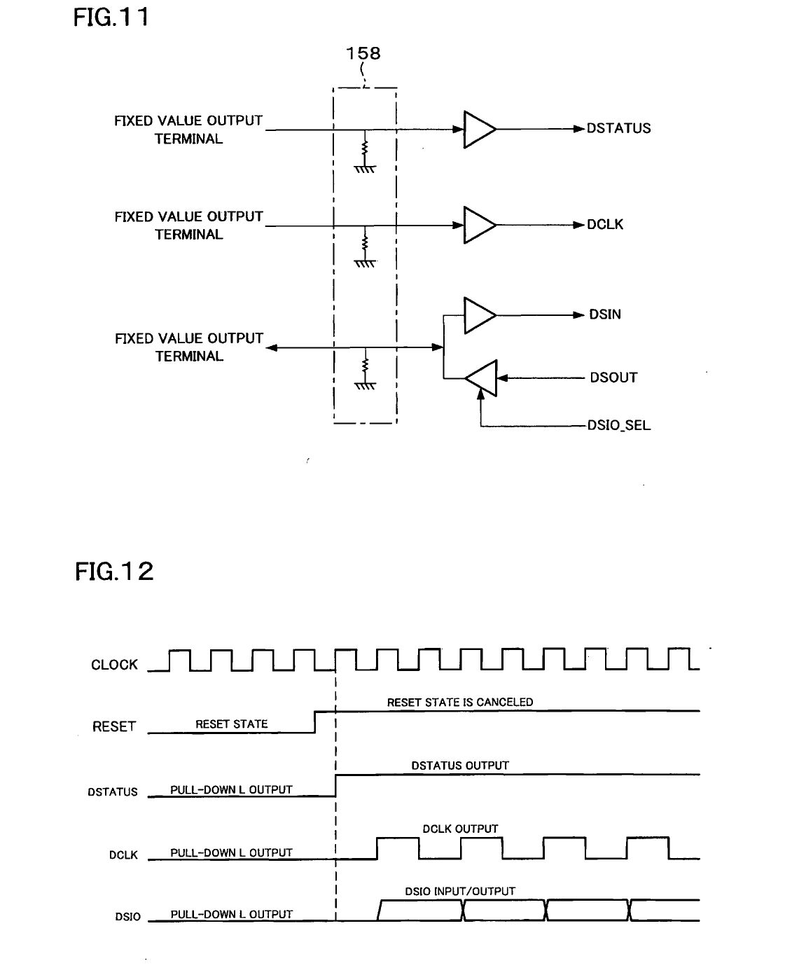

FIGS. 11 and 12 are diagrams illustrative of a modification of the debugging tool.

In this modification, the fixed value holding section of the debugging tool includes pull-down resistors. The configuration and the operation of the debugging tool are described below.

The debugging tool includes a fixed value holding section 158 (fixed value output section) shown in FIG. 11. The fixed value holding section 158 includes pull-down resistors connected to the fixed value output terminals 140. Therefore, when the debugging tool (fixed value output terminals 140) is connected to the user board 12, signals set the L level are input to the fixed value input terminals 40 (test mode pin 42, scan mode pin 44, and bist mode pin 46) of the microcomputer 20. When the reset IC 16 outputs the reset signal set at the first level, fixed values set at the L level are input to and held in the fixed value holding section 50 (flip-flops 52 to 56). When the signal generation section 80 detects that the pattern of the fixed values input to the fixed value holding section 50 satisfies a specific pattern, the signal generation section 80 outputs a detection signal to the debugging module 60.

When the reset IC 16 outputs the reset signal set at the second level, the debugging module 60 starts the debugging operation. In more detail, the debugging module 60 outputs the DSTATUS signal and the DCLK signal to the debugging communication section 160 through the fixed value input terminals 40 and the fixed value output terminals 140. The debugging communication section 160 starts the debugging communication operation of transmitting and receiving debugging data to and from the debugging module 60 by being triggered by the DSTATUS signal and (or) the DCLK signal (detecting transition to the debugging mode).

FIG. 12 shows a timing chart of the debugging tool. As shown in FIG. 12, when the reset signal is set at the first level, the DSTATUS signal, the DCLK signal, and the DSIO signal are set at the L level by the pull-down resistors. When the reset signal has changed to the second level, the DSTATUS signal and the DCLK signal are input from the debugging module 60, and the DSIO signal is transmitted and received to and from the debugging module 60.

According to this debugging tool, the debugging communication section 160 starts the debugging operation based on the signal from the debugging module. Specifically, since the debugging tool can start the debugging operation without inputting the reset signal to the debugging tool, the terminal configuration of the user board 12 and the debugging tool can be simplified. Moreover, since it is unnecessary to provide a select circuit in the debugging tool, the configuration of the debugging tool can be simplified.

As another modification, the fixed value holding section 158 may include pull-up resistors instead of the pull-down resistors. Specifically, the above-described effects can be obtained by combining the pull-up resistors or the pull-down resistors forming the fixed value holding section 158 to generate signals with a specific pattern to be detected by the signal generation section 80. In this modification, the fixed value holding section 158 may be disposed outside the debugging module (on the user board 12 or in the integrated circuit device 20). In this modification, the debugging system may further include a fixed value output section (not shown) for outputting a fixed value outside the debugging module (e.g. on the user board 12). This makes it possible to cause the integrated circuit device to perform various operations such as the test mode operation.

2. Microcomputer

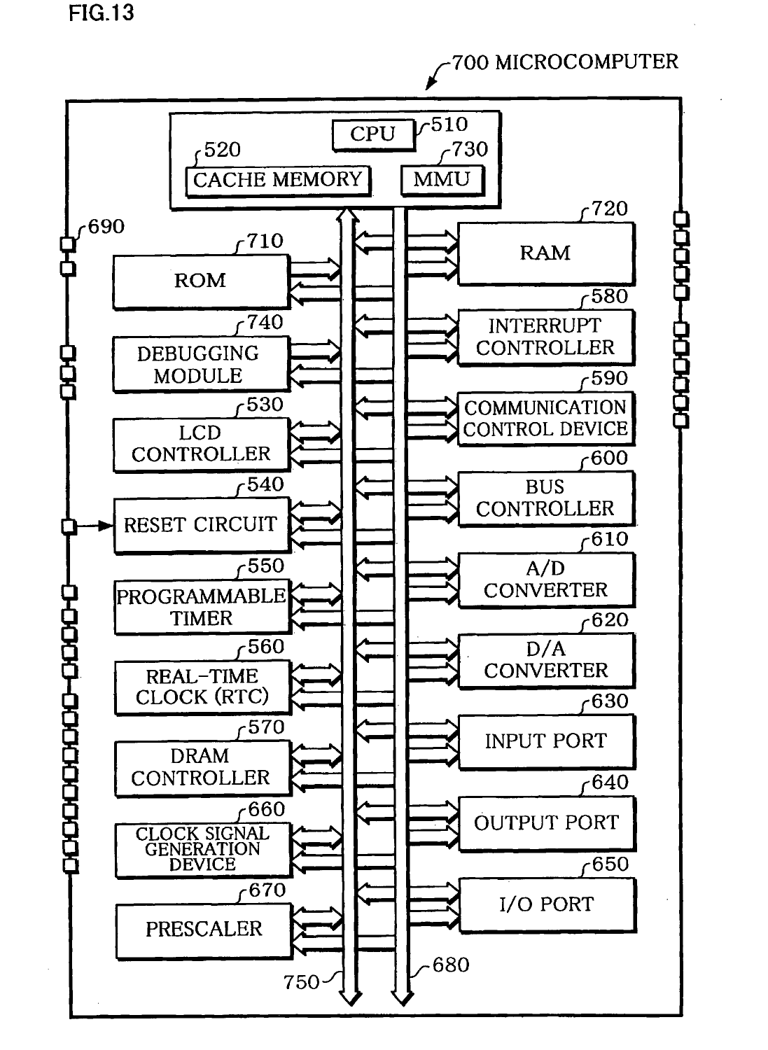

FIG. 13 shows an example of a hardware block diagram of a microcomputer according to this embodiment.

A microcomputer 700 includes a CPU 510, a cache memory 520, a RAM 710, a ROM 720, an MMU 730, an LCD controller 530, a reset circuit 540, a programmable timer 550, a real-time clock (RTC) 560, a DRAM controller 570, an interrupt controller 580, a communication control device (serial interface) 590, a bus controller 600, an A/D converter 610, a D/A converter 620, an input port 630, an output port 640, an I/O port 650, a clock signal generation device 660, a prescaler 670, a general-purpose bus 680 which connects these sections, a debugging module 740, a dedicated bus 750, various pins 690, and the like.

The debugging module 740 has the configuration described with reference to FIG. 2, for example.

3. Electronic Instrument

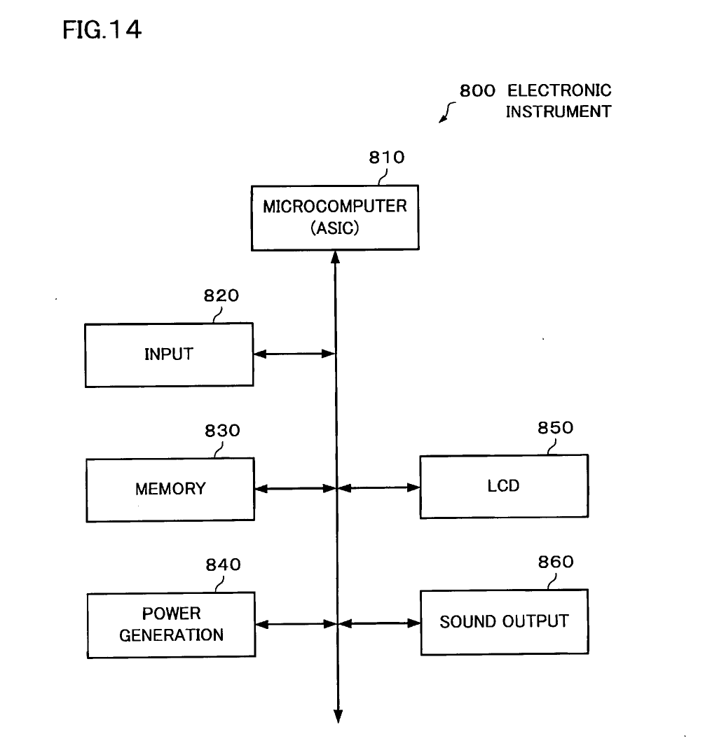

FIG. 14 shows an example of a block diagram of an electronic instrument according to this embodiment. An electronic instrument 800 includes a microcomputer (or ASIC) 810, an input section 820, a memory 830, a power generation section 840, an LCD 850, and a sound output section 860.

The input section 820 is used for inputting various types of data. The microcomputer 810 performs various processes based on data input using the input section 820. The memory 830 functions as a work area for the microcomputer 810 and the like. The power generation section 840 generates power used in the electronic instrument 800. The LCD 850 is used for outputting various images (e.g. character, icon, and graphic) displayed by the electronic instrument.

The sound output section 860 is used for outputting various types of sound (e.g. voice and game sound) output from the electronic instrument 800. The function of the sound output section 860 may be implemented by hardware such as a speaker.

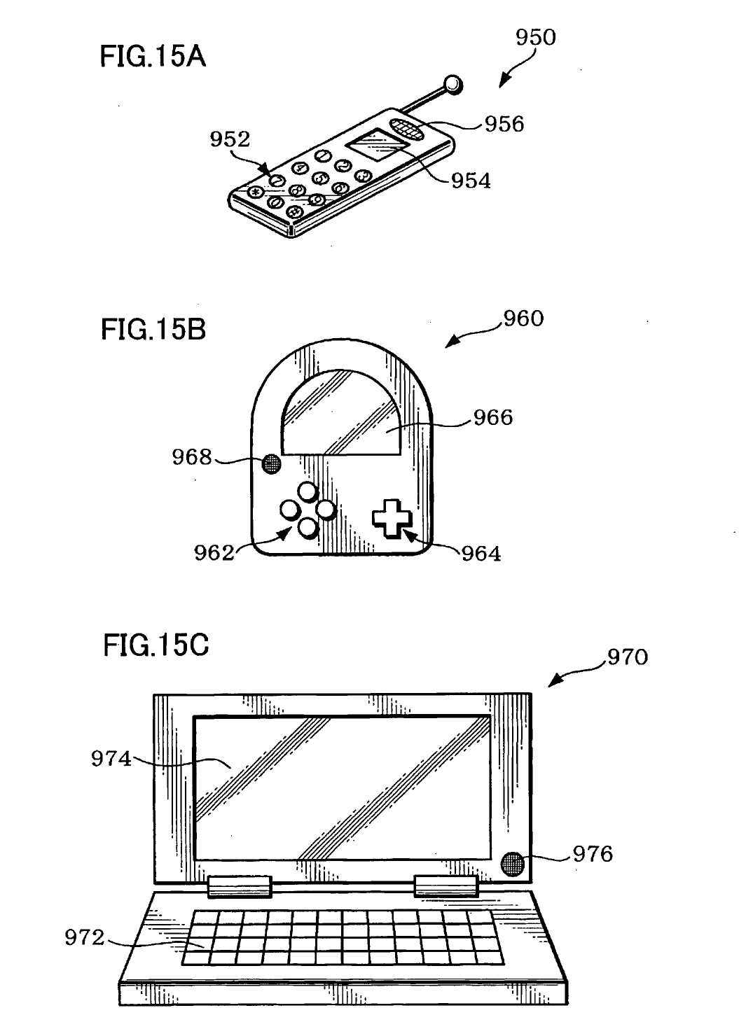

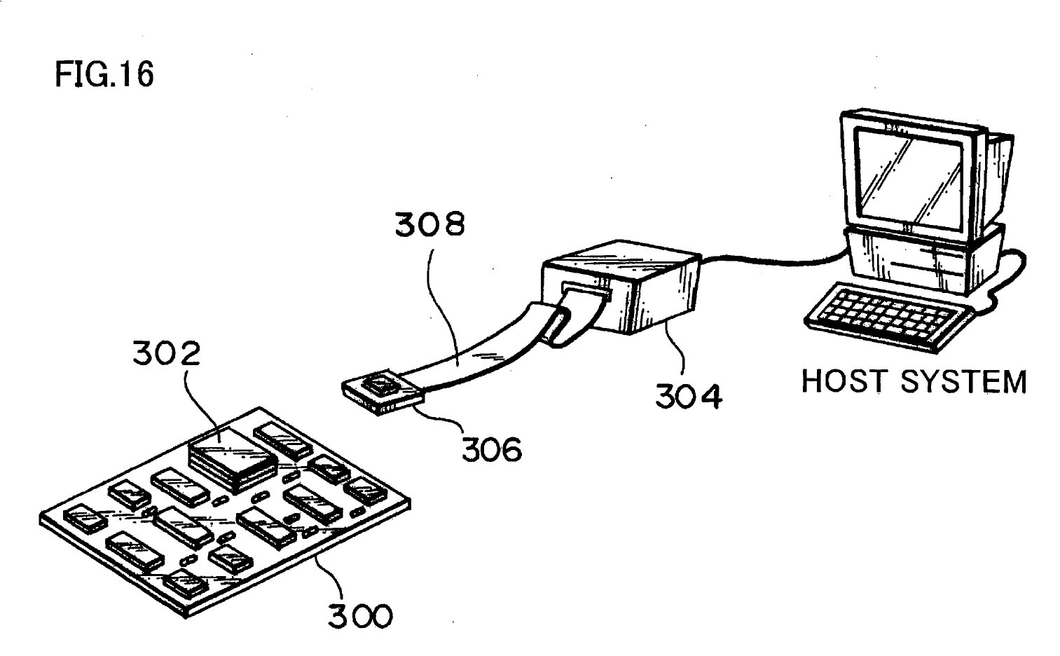

FIG. 15A shows an example of an outside view of a portable telephone 950 which is one type of electronic instrument. The portable telephone 950 includes dial buttons 952 which function as the input section, an LCD 954 which displays a telephone number, a name, an icon, and the like, and a speaker 956 which functions as the sound output section and outputs voice.

FIG. 15B shows an example of an outside view of a portable game device 960 which is one type of electronic instrument. The portable game device 960 includes operation buttons 962 which function as the input section, an arrow key 964, an LCD 966 which displays a game image, and a speaker 968 which functions as the sound output section and outputs game sound.

FIG. 15C shows an example of an outside view of a personal computer 970 which is one type of electronic instrument. The personal computer 970 includes a keyboard 972 which functions as the input section, an LCD 974 which displays a character, a figure, a graphic, and the like, and a sound output section 976.

A highly cost-effective electronic instrument which is inexpensive and exhibits a high image processing speed can be provided by incorporating the microcomputer according to the above embodiment in the electronic instruments shown in FIGS. 15A to 15C.

As examples of the electronic instrument for which this embodiment can be utilized, various electronic instruments using an LCD such as a personal digital assistant, a pager, an electronic desk calculator, a device provided with a touch panel, a projector, a word processor, a viewfinder or direct-viewfinder video tape recorder, and a car navigation system can be given in addition to the electronic instruments shown in FIGS. 15A, 15B, and 15C.

The invention is not limited to the above embodiments. Various modifications and variations may be made without departing from the spirit and scope of the invention. In particular, the invention includes an integrated circuit device and a microcomputer configured so that functions equivalent to various circuits provided in the microcomputer 20 and the debugging tool 100 are realized on the user board 12, and an electronic instrument, a debugging tool, and a debugging system including the same.

Although only some embodiments of the invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An integrated circuit device including a debugging module for on-chip debugging and a CPU, the integrated circuit device comprising:
a fixed value input terminal through which a signal from outside is input;
a fixed value holding section which receives a signal input through the fixed value input terminal and holds a fixed value when a reset signal is set at a first level; and
a control section which controls the fixed value held in the fixed value holding section not to change when the reset signal is set at a second level.

2. The integrated circuit device as defined in claim 1,
wherein the control section includes a circuit which controls a signal from the fixed value input terminal to be input to the fixed value holding section when the reset signal is set at the first level, or to be input to the debugging module when the reset signal is set at the second level.

3. The integrated circuit device as defined in claim 1,
the fixed value input terminal being used for inputting the fixed value when the reset signal is set at the first level, and used for communication of the debugging module when the reset signal is set at the second level; and
the debugging module communicating with an external debugging tool through the fixed value input terminal when the reset signal is set at the second level.

4. The integrated circuit device as defined in claim 1,
wherein the fixed value holding section includes a flip-flop for holding the fixed value; and
wherein the control section includes a select circuit which selects a signal from the fixed value input terminal or a signal output from the flip-flop based on the reset signal, and controls the selected signal to be input to the flip-flop.

5. The integrated circuit device as defined in claim 1, comprising:
a plurality of the fixed value input terminals, the fixed value holding section holding a plurality of the fixed values from the fixed value input terminals while respectively associating the fixed values with the fixed value input terminals; and
a signal generation section which determines whether or not combination of the fixed values satisfies a predetermined pattern, and generates a predetermined debugging signal when the combination of the fixed values satisfies the predetermined pattern,
wherein the debugging module performs the on-chip debugging based on the predetermined debugging signal.

6. The integrated circuit device as defined in claim 1, comprising:
no dedicated external terminal for the debugging module to communicate with a debugging communication section included in the external debugging tool.

7. A microcomputer comprising the integrated circuit device as defined in claim 1.

8. An electronic instrument comprising:
the microcomputer as defined in claim 7;
a data source of data to be processed by the microcomputer; and
an output device which outputs data processed by the microcomputer.

9. A debugging tool which communicates with an integrated circuit device including a debugging module for on-chip debugging and a CPU, the debugging tool comprising:
a fixed value output terminal through which a signal is output to the outside;
a fixed value holding section which holds a fixed value to be output to the outside through the fixed value output terminal when a reset signal is set at a first level; and
a debugging communication section which communicates with the integrated circuit device through the fixed value output terminal when the reset signal is set at a second level,
the fixed value output terminal being used for outputting the fixed value when the reset signal is set at the first level, and used for communication of the debugging communication section when the reset signal is set at the second level.

10. The debugging tool as defined in claim 9, wherein the fixed value holding section includes a pull-up or pull-down resistor.

11. The debugging tool as defined in claim 9, comprising:
no dedicated external terminal for the debugging communication section to communicate with the debugging module.

12. A debugging system including an integrated circuit device which includes a debugging module for on-chip debugging and a CPU, and a debugging tool which communicates with the integrated circuit device,
wherein the integrated circuit device includes:
a fixed value input terminal through which a signal from outside is input;
a fixed value holding section which receives a signal input through the fixed value input terminal and holds a fixed value when a reset signal is set at a first level; and
a control section which controls the fixed value held in the fixed value holding section not to change when the reset signal is set at a second level;
wherein the debugging tool includes:
a fixed value output terminal through which a signal is output to the outside;
a fixed value holding section which holds a fixed value to be output to the outside through the fixed value output terminal when the reset signal is set at the first level; and
a debugging communication section which communicates with the integrated circuit device through the fixed value output terminal when the reset signal is set at the second level;
wherein the fixed value input terminal is used for inputting the fixed value when the reset signal is set at the first level, and used for communication of the debugging module when the reset signal is set at the second level;
wherein the fixed value output terminal is used for outputting the fixed value when the reset signal is set at the first level, and used for communication of the debugging communication section when the reset signal is set at the second level;
wherein the fixed value holding section in the integrated circuit device communicates with the fixed value holding section in the debugging tool through the fixed value input terminal and the fixed value output terminal when the reset signal is set at the first level; and
wherein the debugging module communicates with the debugging communication section through the fixed value input terminal and the fixed value output terminal when the reset signal is set at the second level.

13. The debugging system as defined in claim 12,
wherein the integrated circuit device includes no dedicated external terminal for the debugging module to communicate with the debugging communication section.
